(19) United States
(12) Patent Application Publication
(10) Pub. No.: US 2007/0240225 A1
(43) Pub. Date: Oct. 11, 2007

(54) Architecture for automatic HTTPS boundary identification

(76) Inventors: Theodore Jack London Shrader, Austin, TX (US); David Kingsley Clark, Cedar Park, TX (US); David Salinas, Pflugerville, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/402,035

(22) Filed: Apr. 10, 2006

(51) Int. Cl. G06F 11/00; G06F 15/173; G06F 12/14; G06F 12/16; G06F 15/18; G08B 23/00

(52) U.S. Cl. 726/25; 709/224; 709/225

(57) ABSTRACT

A method, system, and computer program product that enables a web designer/architect to be dynamically notified of the presence of unsecured content within a secure web site based on testing or users browsing activities. A boundary error detection and reporting (BEDR) utility is added to the web browser, web application server, or both. The BEDR utility provides/activates a function that tracks a user's movements on the secure web site. Whenever a link crosses an HTTP-to-HTTPS boundary, the BEDR utility records the transition as informational. The utility also records any HTPS-to-HTTP boundary crossings and any objects not from the same HTTPS source as an error. The BEDR utility automatically addresses the boundary problem, such as through stripping out code or objects, and also automatically reports these boundary crossings to a Web designers and/or architects, who may utilize this reported data to correct these errors on the secure site.

### BACKGROUND OF THE INVENTION

1. Technical Field

The present invention relates generally to user accessible networks and in particular to accessing content on user accessible networks. Still more particularly, the present invention relates to a method, system, and the computer program product for enhancing the security of user access to secure content on user accessible networks.

2. Description of the Related Art

The Internet and other user-accessible networks provide a wide variety of content to which a user may access. Typically this content is stored on a web server and is generally accessible as a web page (or web object, not necessarily in html format) to anyone having access to the network (via a web browser application on a network-connected computer/device, for example). Certain types of content that is placed on a web site is authenticated as being secure content and is typically not meant to be accessible to everyone. Because of the need to access this secure content securely, the Internet standards board has provided a secure access protocol in lieu of the standard Hypertext transfer protocol (HTTP). This secure access protocol is secure http (or HTTPS), and content accessed on an HTTPS site is presumed to be secure with authenticated and encrypted traffic between the Web server and Web client.

Users who access the Internet typically browse from one web site to another via links within the current site or other methods. When accessing a secure site via HTTPS, however, there is a concern that browsing away to another site may compromise the security of the information or data being exchanged at the secure site. Because of this, web designers and/or the designers of the web browser applications include in the browser a default pop-up function that notifies a user when the user is migrating away from a secure site to an un-secure site or accessing unsecured information/data from within a secure site.

When such activity is detected/encountered, the notification function of the Web browsers typically notifies the user(s) that the loaded HTTPS page contains un-secure (HTTP) elements, and users may be prompted to choose not to load these un-secure elements. Oftentimes, however, users turn off this warning message and allow all elements to be loaded without the prompt/warning appearing. In such an environment, the user may then be working in an unsafe, un-secure mode with the opportunity for malevolence to their data and/or system. With the vast amount of pages and objects that may exist on a web site and the ways that these objects may be included in the site, there needs to be away for Web designers/architects to quickly identify this error state (i.e., a state in which un-secure content is present on or accessible via the secure site) and content in error.

### SUMMARY OF THE INVENTION

Disclosed is a method, system, and computer program product that enables a web designer/architect to be dynamically notified of the presence of unsecured content within a secure web site based on a user's browsing activity. A boundary error detection and reporting (BEDR) utility is added to the web browser or web application server. The BEDR utility provides/activates a function that tracks a user's movements on the secure web site or as part of a recursive crawling of links, given a starting URL. Whenever a link crosses an HTTP-to-HTTPS boundary, the BEDR utility records the transition as informational. For HTTPS pages, if any of the included objects, such as a JavaScript, include content or images that are not from the same HTTPS source, the utility also records/report an error. The recorded/reported error identifies the HTTPS page containing the error as well as the content/elements that did not come from the same trusted HTTPS source.

In one embodiment, the BEDR utility is provided as a plug-in to web browsers (or any Web client application) during use or testing of the secure web site. At the end of the testing run or at a designated checkpoint time, the BEDR utility provides a report of boundary errors and offers to temporarily correct them by communicating with the Web application server to comment out the HTTP inclusion errors. The BEDR utility quickly identifies HTTPS boundary crossings and automatically reports these boundary crossings to a pre-set IP address/email address/repository/server accessible to and monitored by the Web designers, architects, and/or a Web service associated with the Web application server. With this reported data, the web designers/architects are able to correct these errors on the secure site to prevent the user from later encountering this unsecured browser state.

In one embodiment, the BEDR utility is also utilized by end-users to help alert the end-user in more detail of Web content security problems. For both testing and end-user purposes, the BEDR utility may comprise an additional feature to clear the HTTPS authentication data to allow the user or tester to log in with a different user ID and password. This allows the tester or user to end the old and establish a new HTTPS session without having to close the Web browser application.

In another embodiment, a server-level BEDR utility is provided as a plug-in to a Web application server. The server-level BEDR utility checks each HTTPS page sent and automatically comments out any HTTP inclusion (or takes another action to prevent the inclusion of the unsecured HTTP objects.). The server-level BEDR utility further logs all of these detected errors, and automatically notifies the web designer or architects. Additionally, in one embodiment, when provided in this plug-in form, the server-level BEDR utility also consults an un-trusted list of URLs or sources to automatically exclude content from these un-trusted sources from appearing on the server's web page.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of a computer network within which the various features of the invention may be implemented;

FIG. 2 is a block diagram representation of a data processing system that may be utilized as either the web server or web browser/user devices enhanced with a boundary error detection and reporting (BEDR) utility in the above computer network according to one embodiment of the invention; and

FIG. 3 is a flow chart of the process of detecting and reporting boundary errors during web browsing on a secure site in accordance with one embodiment of the invention.

### DETAILED DESCRIPTION OF AN ILLUSTRATIVE EMBODIMENT

The present invention provides a method, system and computer program product that enables a web designer to be dynamically notified of the presence of unsecured content within a secure web site based on a user's browsing activity or through design or automated testing.

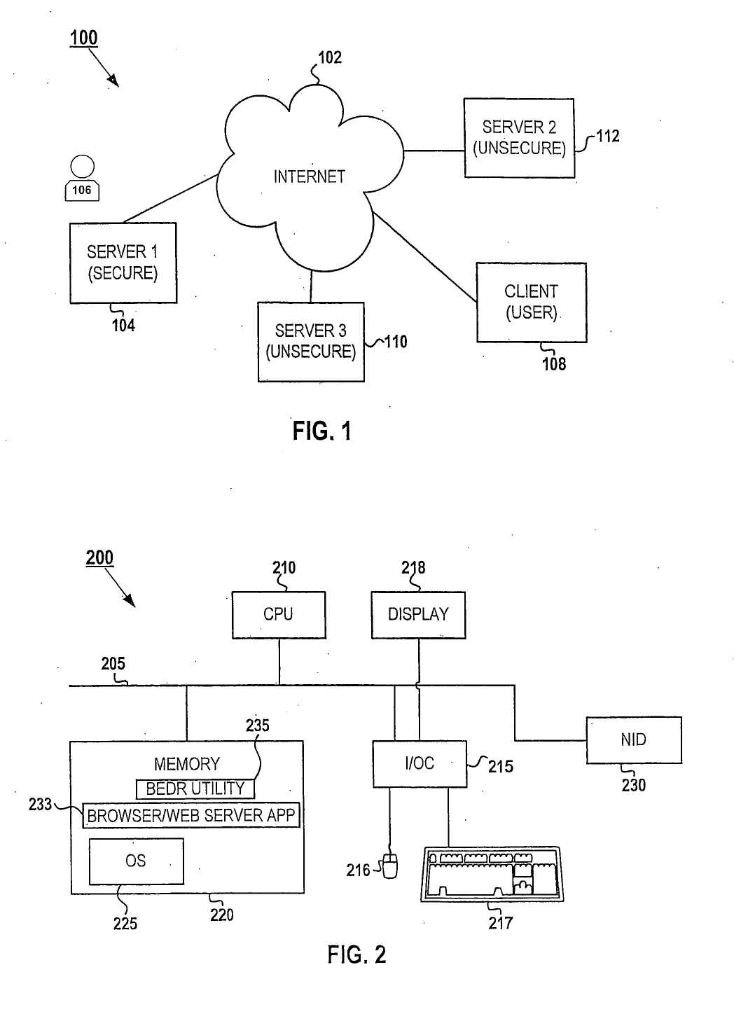

With reference now to the figures, FIG. 1 depicts a pictorial representation of a network of data processing systems (Network system 100) in which the present invention may be implemented. Network system 100 contains network connectivity 102 (also referred to as a network backbone/infrastructure), which is the medium utilized to provide communication links between various devices and computers connected together within network system 100. Network 102 may include connections, such as wire, wireless communication links, or fiber optic cables.

In the depicted example, network system 100 comprises client/user device 108 (web browser), secure web server 104, several unsecured web servers 110 and 112 connected to network 102. Secure web server 104 provides content via a web page that is created/designed by web page designer/architect 106.

For purposes of the invention, client/user device 108 represents a device on which web browser software is executed, while servers 104/110/112 represent devices, accessible to the client via the network 102 on which web pages are provided. Client/user device 108 and servers 104/110/112 may be, for example, personal computers or network computers. Network system 100 may include additional servers, clients, and other devices not shown.

In the described embodiment, network system 100 is the Internet with network connectivity 102 representing a worldwide collection of networks and gateways that utilize the Hypertext transfer protocol (HTTP) and Transmission Control Protocol/Internet Protocol (TCP/IP) suite of protocols to communicate with one another. Of course, network system 100 also may be implemented as a number of different types of networks, such as an intranet, a local area network (LAN), or a wide area network (WAN), for example. FIG. 1 is intended as an example, and does not imply any architectural limitations on the present invention.

Referring now to FIG. 2, there is depicted a block diagram representation of a data processing (or computer) system that may be implemented as a server, such as secure server 104 in FIG. 1 or as client 108 in accordance with the illustrative embodiment of the present invention. Computer system 200 comprises processor 210 coupled to memory 220, and input/output (I/0) controller 215 via system bus 205. I/O controller 215 provides the connectivity to and/or control over input/output devices, including mouse 216, keyboard 217 and display device 218.

Computer system 200 also comprises a network interface device (NID) 230 utilized to connect computer system 200 to another computer system and/or computer network (as illustrated by FIG. 1). NID 230 provides interconnectivity to an external network through a gateway or router, or similar device. NID 230 may be an Ethernet card or modem, for example, depending on the type of network (e.g., local area network (LAN) or wide are network (WAN), Internet) to which the computer system 200 is connected.

In one embodiment, the hardware components of computer system 200 are of conventional design. Computer system 200 may also include other components (not shown) such as fixed disk drives, removable disk drives, CD and/or DVD drives, audio components, modems, network interface components, and the like. It will therefore be appreciated that the system described herein is illustrative and that variations and modifications are possible. Further, the techniques for messaging middleware functionality may also be implemented in a variety of differently-configured computer systems. Thus, while the invention is describe as being implemented in a computer system 200, those skilled in the art appreciate that various different configurations of computer systems exists and that the features of the invention are applicable regardless of the actual configuration of the computer system.

Located within memory 220 and executed on processor 210 are a number of software components, including operating system (OS) 225 (e.g., Microsoft Windows®, a trademark of Microsoft Corp, or GNU®/Linux®, registered trademarks of the Free Software Foundation and The Linux Mark Institute) and a plurality of software applications, including web browser 233. Notably, web browser 233 is illustrated having included therein boundary error detection and reporting (BEDR) utility 235, which as is further described below, is the engine that powers the most of the functional features of the invention. In an alternate implementation, the BEDR utility is a separate utility from the web browser and plugs into existing web browser code to monitor and report on boundary crossings during browsing activities at a secure web site. Notably, as utilized herein the term web browser may be extended to refer to any web client application.

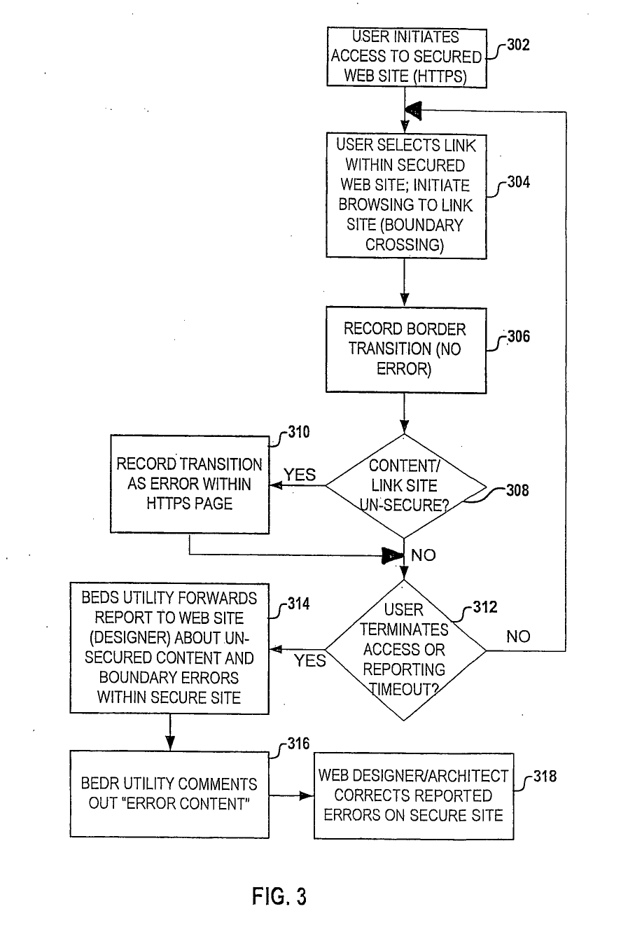

Processor 210 executes these (and other) application programs (e.g., network connectivity programs) as well as OS 225, which supports the application programs. According to the illustrative embodiment, processor 210 executes OS 225, web browser 233, and BEDR utility 235 to provide/enable the boundary recording and reporting and other related features and functionality described herein and illustrated by FIG. 3.

Implementation of the invention thus involves adding the BEDR utility to the web browser, wherein the monitoring, recording and reporting processes occur at the user-level. In an alternate embodiment, the BEDR utility is actually added to the web server application at the server and performs the monitoring, recording (and reporting) at the server-level. BEDR utility may be provided as an off-the-shelf product that is added as a plug-in to a web browser or web-browser application during testing of the secure site.

In one embodiment, the BEDR utility is provided as a plug-in to web browsers during testing or use of the secure web site. At the end of the testing run or at a designated checkpoint time, the BEDR utility provides a report of boundary errors and offers to temporarily correct them by commenting out the HTTP inclusion errors. Alternatively, in one embodiment, the utility may automatically communicate with the Web server to comment or strip out the code with the boundary problem until the Web designer or architect could analyze and address the problem. Also, the utility may use pre-defined and extendable rules to automatically correct boundary problems with or without the future review of a Web designer or architect. As utilized herein, the term “comment” or “comment out” generally refers to all actions the Web client or Web application server may take, including using HTML or tag-appropriate comment tags to wrap around the problem code or stripping the code completely from the Web page transmitted from the Web server.

In one embodiment, the BEDR utility is also utilized by end-users to help alert the end-user in more detail of Web content security problems. For both testing and end-user purposes, the BEDR utility may comprise an additional feature to clear the HTTPS authentication data to allow the user or tester to log in with a different user ID and password. This allows the tester or user to end the old and establish a new HTTPS session without having to close the Web browser application.

In another embodiment, a server-level BEDR utility is provided as a plug-in to a Web application server. The server-level BEDR utility checks each HTTPS page sent and automatically comments out any HTTP inclusion (or takes another action to prevent the inclusion of the unsecured HTTP objects.). The server-level BEDR utility further logs all of these detected errors, and automatically notifies the web designer or architects. Alternatively, the utility could also consult other knowledge-based rules for the automatic correction of the https boundary problem. Additionally, in one embodiment, when provided in this plug-in form, the server-level BEDR utility also automatically consults a pre-created list of un-trusted URLs or sources to automatically exclude content from these un-trusted sources from appearing on the server web page.

Once the BEDR utility is installed on the system, the BEDR utility provides/activates a function that tracks a user's movements (via the web browser or other Web-aware application on the client device) on the secure web site. In one embodiment, this tracking is also implemented when the user performs a recursive crawling of links, given a starting URL. Whenever a link crosses an HTTP-to-HTTPS boundary, the BEDR utility records the transition as informational. This information may be recorded in memory or some other available storage (not shown). For HTTPS pages, if any of the included objects such as a JavaScript includes content or images that are not from the same HTTPS source, the utility also records/reports an error. In one embodiment, the recorded/reported error identifies the HTTPS page containing the error as well as the content/elements that did not come from the same trusted HTTPS source.

The BEDR utility quickly identifies HTTPS boundary crossings and automatically records and later reports these boundary crossings to a pre-set location. In the user-level implementation, the recorded information is forwarded to an IP address/email address/repository/server that is monitored by and accessible to the web designers and/or architects of the secure web site. Alternatively, the Web browser could use a Web service associated with the Web application server to report and automatically act upon boundary problems. With this reported data, the web designers/architects are then able to correct these errors on the secure site to prevent the user from later encountering this unsecured browser state.

With specific reference now to FIG. 3, wherein is illustrated the process steps completed by the BEDR utility 240, according to one embodiment. As shown by block 302, the process begins when a user initiates access to the secured (https) web site. While browsing at or interacting with the site, the user selects links within the site or access content within the site as shown at block 304. During this process, indirect access of boundary content may occur when/if the user accesses an HTTPS URL that includes HTTP objects. Whenever these actions trigger a boundary crossing or the content is recognized as being from a different source (other than the secure site), the activity (i.e., boundary transition) is recorded by the BEDR utility, as indicated at block 306. Then a determination is made at block 308 whether the boundary crossing was to an un-secure site (or unsecured content accessed).

When BEDR utility recognizes the boundary crossing was to an un-secure site (or accessed un-secure content), the BEDR utility tags the activity (i.e., boundary crossing) as an error within the https page, as shown at block 310. A determination is then made at block 312 whether the user terminates the access to the secure site or whether a reporting timeout period (or a pre-set checkpoint time) has expired. If not, the BEDR continues to monitor and record activity occurring during the user's browsing and/or interaction with/on the secure site.

However, at the end of the crawling or at the pre-set checkpoint time, the BEDR utility automatically reports on the boundary crossings and whether any errors were detected, as indicated at block 314. The BEDR utility then comments out the various contents that lead to the occurrence of the errors, as shown at block 316. The utility is able to communicate with the Web server to use predefined rules to automatically address boundary problems. When the BEDR utility is being implemented from the user-level and has network access to the HTTPS server, the user-level BEDR utility is provided the functionality to enable the user-level BEDR utility to comment out the offending objects at the HTTPS server. The information is then stored at the server or at the location to which the information is forwarded until the web designer/architect is able to correct these detected errors. Using the information provided by the BEDR utility, the web designers/architects are able to quickly identify HTTP and HTTPS boundary errors, either automatically or on a user flow basis, and the web designers/architects are then able to correct these errors, as indicated at block 318.

Thus, as described, the invention enables both manual and/or automatic boundary correction on both the web client and web application server. In one embodiment, the web server is designed with the greater ability to catch boundary problems and take actions to prevent the problem(s) from being passed to the user. One such implementation (which provides a least intrusive action) is for the web server to strip out the problem code from the code that is transmitted to the web client. In this implementation, the original content on the web server remains the same, and the errors/problems are logged for the web designer or administrator to review at a later time to provide more permanent action/correction/fix. In another embodiment, the BEDR utility executes on the web application server and checks a knowledge-base of rules to determine if an automatic corrective action should occur. The utility may then implement this corrective action automatically.

The user flow detection ability is particularly valuable in tests where form data, user ID authentication, or both need to be entered into forms to proceed to the next page and thus cannot be reached through an automatic web crawling process. In one embodiment, the BEDR also provides a notice to the web designer/architecture to fix a detected error by moving or copying the HTTP objects to the same trusted HTTPS server and changing the link on the HTTPS page to point to the new HTTPS include. Use off the utility in this matter provides value to Web designers and administrators by helping them catch/locate HTTPS boundary errors before the user sees the errors, and thus the utility may be advantageously incorporated into Web design tools.

As a final matter, it is important that while an illustrative embodiment of the present invention has been, and will continue to be, described in the context of a fully functional computer system with installed management software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as floppy disks, hard disk drives, CD ROMs, and transmission type media such as digital and analogue communication links.

While the invention has been particularly shown and described with reference to a preferred embodiment, it will be understood by those skilled in the art that various changes in form and detail may be made therein without departing from the spirit and scope of the invention.

What is claimed is:

1. In a computer network environment, a method comprising:
tracking activity on a web site;
determining when the activity results in a boundary crossing;
logging the boundary crossing; and
when the boundary crossing involves accessing un-secured content from within a secure website, reporting the transition as an error to a web application server.

2. The method of claim 1, wherein said boundary crossing is one of a first crossing from an http site to an https site and a second crossing from an https site to an http site, wherein the first crossing is recorded as informational and the second crossing is recorded as an error.

3. The method of claim 1, further comprising:
dynamically determining when an object included in the https site comprises content that is not from an https source; and
reporting the inclusion of the object as an error to the web application server.

4. The method of claim 3, wherein said reporting comprises:
identifying the https page that contains the error and the content that does not come from a trusted https source; and
commenting out the non-secure content inclusion errors at the web application server.

5. The method of claim 3,wherein said commenting out comprises one or more of utilizing HTML and tag-appropriate comment tags to wrap around the problem code and striping the problem code from the web page content transmitted from the web application server.

6. The method of claim 1, wherein said reporting comprises forwarding a notification of the error and the associated un-secured content and boundary crossing to a preset electronic address, wherein the preset electronic address is an address which is accessible to web application server personnel.

7. The method of claim 1, further comprising:
enabling a user to login to the https site utilizing in a different user ID and password without closing the web client application within which the error occurred.

8. The method of claim 1, wherein the tracking, recording, and reporting steps are completed at one or more of a web client application and a web application server, said method further comprising:
enabling manual and automatic boundary correction on both the web client and the web application server, wherein when the reporting steps occur at the web application server, server personnel are notified to take actions to remove the reported error from inclusion in the secure site content accessible to web client(s), wherein code associated with the error are removed from the code transmitted to the web client(s), while the original content on the web application server is maintained to enable personnel of the web application server to review and correct the original content.

9. The method of claim 8, wherein when the reporting occurs at the web application server, said method further comprises:
checking a knowledge-base of rules to determine if an automatic corrective action may be implemented; and
when an automatic corrective action may be implemented, automatically implementing the corrective action.

10. A computer device comprising:
a processor;
first code executing on said processor for enabling a web application that comprises secured content; and
second code executing on the processor for performing the functions of claim 1.

11. A system comprising:
a processor;
a network connectivity device for coupling the system to a secure web application server; and
program code executing on the processor to performs the steps of claim 1.

12. A computer program product comprising:
a computer readable medium; and
program code for execution on a device within a web-based network, said code comprising code that when executed on a processor performs the functions of:
tracking activity on a web site;
determining when the activity results in a boundary crossing;
logging the boundary crossing; and
when the boundary crossing involves accessing un-secured content from within a secure website, reporting the transition as an error to a web application server.

13. The computer program product of claim 12, wherein said boundary crossing is one of a first crossing from an http site to an https site and a second crossing from an https site to an http site, wherein the first crossing is recorded as informational and the second crossing is recorded as an error.

14. The computer program product of claim 12, further comprising code for:
dynamically determining when an object included in the https site comprises content that is not from an https source; and
reporting the inclusion of the object as an error to the web application server.

15. The computer program product of claim 14, wherein said code for reporting comprises code for:
identifying the https page that contains the error and the content that does not come from a trusted https source; and
commenting out the non-secure content inclusion errors at the web application server.

16. The computer program product of claim 14,wherein said code for commenting out comprises code for one or more of utilizing HTML and tag-appropriate comment tags to wrap around the problem code and striping the problem code from the web page content transmitted from the web application server.

17. The computer program product of claim 12, wherein said code for reporting comprises code for forwarding a notification of the error and the associated un-secured content and boundary crossing to a preset electronic address, wherein the preset electronic address is an address which is accessible to web application server personnel.

18. The computer program product of claim 12, further comprising code for:
enabling a user to login to the https site utilizing in a different user ID and password without closing the web client application within which the error occurred.

19. The computer program product of claim 12, wherein the tracking, recording, and reporting steps are completed at one or more of a web client application and a web application server, said program code further comprising code for:
enabling manual and automatic boundary correction on both the web client and the web application server, wherein when the reporting steps occur at the web application server, server personnel are notified to take actions to remove the reported error from inclusion in the secure site content accessible to web client(s), wherein code associated with the error are removed from the code transmitted to the web client(s), while the original content on the web application server is maintained to enable personnel of the web application server to review and correct the original content.

20. The computer program product of claim 19, wherein when the reporting occurs at the web application server, said program code further comprises code for:
checking a knowledge-base of rules to determine if an automatic corrective action may be implemented; and
when an automatic corrective action may be implemented, automatically implementing the corrective action.
